(19) United States
(12) Patent Application Publication
(10) Pub. No.: US 2017/0308649 A1
(43) Pub. Date: Oct. 26, 2017

(54) INTEGRATING TRAUMA DOCUMENTATION INTO AN ELECTRONIC MEDICAL RECORD

(71) Applicant: CERNER INNOVATION, INC., Kansas City, KS (US)

(72) Inventors: ANIL TREVOR LODHIA, WASHINGTON, DC (US); CHAO SHI, SILVER SPRING, MD (US); SIVA KUMAR NALANAGULA, SILVER SPRING, MD (US); KRITHIGA SUNDAR RAJ, SILVER SPRING, MD (US)

(21) Appl. No.: 15/137,762

(22) Filed: Apr. 25, 2016

(51) Int. Cl. G06F 19/00

(52) U.S. Cl. CPC G06F 19/322; G06F 19/3425; G06F 19/3487

(57) ABSTRACT

Methods, computer systems, and computer storage media are provided for integrating trauma documentation into an electronic medical record (EMR). After a trauma call, indicating that a patient is being admitted to a trauma facility, is initiated, an indication is received and communicated to trauma personnel at the trauma facility via at least one personnel device. Preliminary information is received from emergency medical services corresponding to the patient and populates at least one trauma template that is used to build trauma documentation comprising modal windows. At least one clinician of the trauma personnel is able to open up to two modal windows, corresponding to a component container or a survey container, of a trauma display. Additional information is received from the at least one clinician or at least one medical device to generate real-time structured documentation in an electronic medical record of the patient corresponding to the trauma call.

### BACKGROUND

Trauma is the leading cause of death and acquired disability in children and young adults. Early care after injury has an important impact on outcome, making the initial management of injured patients (“trauma resuscitation”) a critical phase in their care. Although a standardized evaluation and management protocol (Advanced Trauma Life Support) has been shown to improve outcomes related to trauma resuscitation, video review has found an average of 12 deviations from this protocol per resuscitation. Most of these deviations are variations addressing the unpredictability of injured patients and their response to treatment or provider preference. Up to 40% of these deviations, however, can be classified as “errors” and may be directly associated with adverse outcomes, including long-term disability and death.

Computer-aided decision support has been evaluated as one strategy for increasing protocol compliance during trauma resuscitation and improving outcomes after injury. Initial attempts at implementing this strategy have had limited success because of the challenge of capturing and manually entering data that are concurrently emerging in this fast-paced, multidisciplinary setting and the absence of an approach for monitoring workflow in real time and detecting workflow deviations that relate to adverse outcomes.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to integrating trauma documentation into an electronic medical record (EMR). After a trauma call, indicating that a patient is being admitted to a trauma facility, is initiated, an indication is received and communicated to trauma personnel at the trauma facility via at least one personnel device. Preliminary information is received from emergency medical services corresponding to the patient and populates at least one trauma template that is used to build trauma documentation comprising modal windows. At least one clinician of the trauma personnel is able to open up to two modal windows, corresponding to a component container or a survey container, of a trauma display. Additional information is received from the at least one clinician or at least one medical device to generate real-time structured documentation in an electronic medical record of the patient corresponding to the trauma call.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary system for integrating trauma documentation into an EMR, in accordance with an embodiment of the present invention;

FIGS. 3-5 depict illustrative screen displays, in accordance with embodiments of the present invention;

FIG. 6 is a flow diagram showing an exemplary method for integrating trauma documentation into an EMR, in accordance with various embodiments of the present invention; and

FIG. 7 is a flow diagram showing an exemplary method for integrating trauma documentation into an EMR, in accordance with various embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention capture, in real-time, trauma documentation that can be integrated into an EMR, a clinical note, or an NTDB report. To do so, templates comprising embedded logic may be selected based on preliminary information about a trauma event. The templates enable a clinician to interact with only relevant portions of information at a time allowing the clinician to provide real-time information that can be documented where appropriate. Further, the embedded logic enables clinical decision support to be provided by the trauma display. Although described herein with reference to trauma events, trauma documentation, and trauma displays, it is contemplated that embodiments of the present invention may be used for code blue events, medical alerts, and other resuscitations.

Accordingly, in one aspect, an embodiment of the present invention is directed to a method for integrating trauma documentation into an EMR. The method includes receiving an indication that a trauma call has been initiated. The trauma call indicates that a patient is being admitted to a trauma facility. The method further includes communicating the indication to trauma personnel at the trauma facility via at least one personnel device. The method also includes receiving preliminary information from emergency medical services corresponding to the patient, the preliminary information populating at least one trauma template. The trauma template can be used to build trauma documentation comprising modal windows. The method further includes enabling at least one clinician of the trauma personnel to open up to two modal windows of a trauma display. The modal windows correspond to a component container or a survey container. The method also includes receiving additional information from the at least one clinician of the trauma personnel or at least one medical device to generate real-time structured documentation in an electronic medical record of the patient corresponding to the trauma call.

In another aspect of the invention, an embodiment is directed to a method for integrating trauma documentation into an EMR. The method includes receiving a request from at least one clinician of trauma personnel to open a modal window of a trauma display. The modal window corresponds to a component container or a survey container. The method also includes, upon determining more than one open modal window is already open: 1) determining the modal window is a same type as a first open modal window, closing the first open modal window, and opening the modal window; or 2) the modal window is a same type as a second open modal window, closing the second open modal window, and opening the modal window. The method further includes, upon determining less than two modal windows are currently open, opening the modal window.

In a further aspect, an embodiment is directed to a computerized system that includes one or more processors and a non-transitory computer storage medium storing computer-useable instructions that, when used by the one or more processors, cause the one or more processors to: receive a request from at least one clinician of trauma personnel to open a modal window of a trauma display, the modal window corresponding to a component container or a survey container; upon determining more than one open modal window is already open: determine the modal window is a same type as a first open modal window, close the first open modal window, and open the modal window; or determine the modal window is a same type as a second open modal window, close the second open modal window, and open the modal window; and upon determining less than two modal windows are currently open, open the modal window.

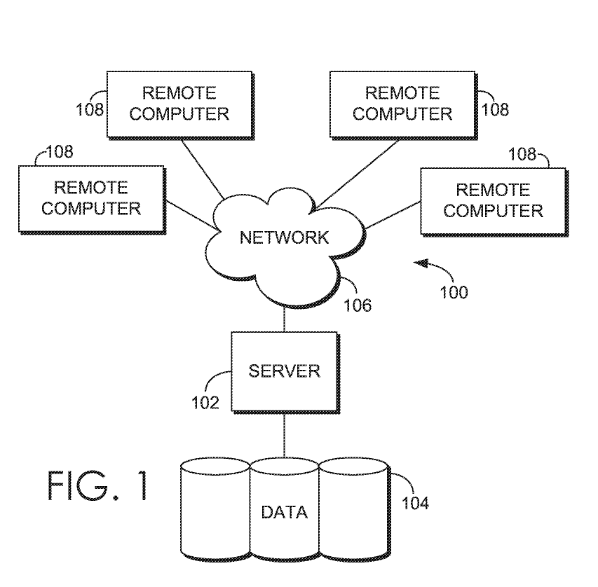

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, ambulatory settings, medical billing and financial offices, hospital administration settings, home healthcare environments, clinicians' offices, Center for Disease Control, Centers for Medicare & Medicaid Services, World Health Organization, any governing body either foreign or domestic, Health Information Exchange, and any healthcare/government regulatory bodies not otherwise mentioned. Clinicians may comprise a treating physician or physicians; specialists such as intensivists, surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

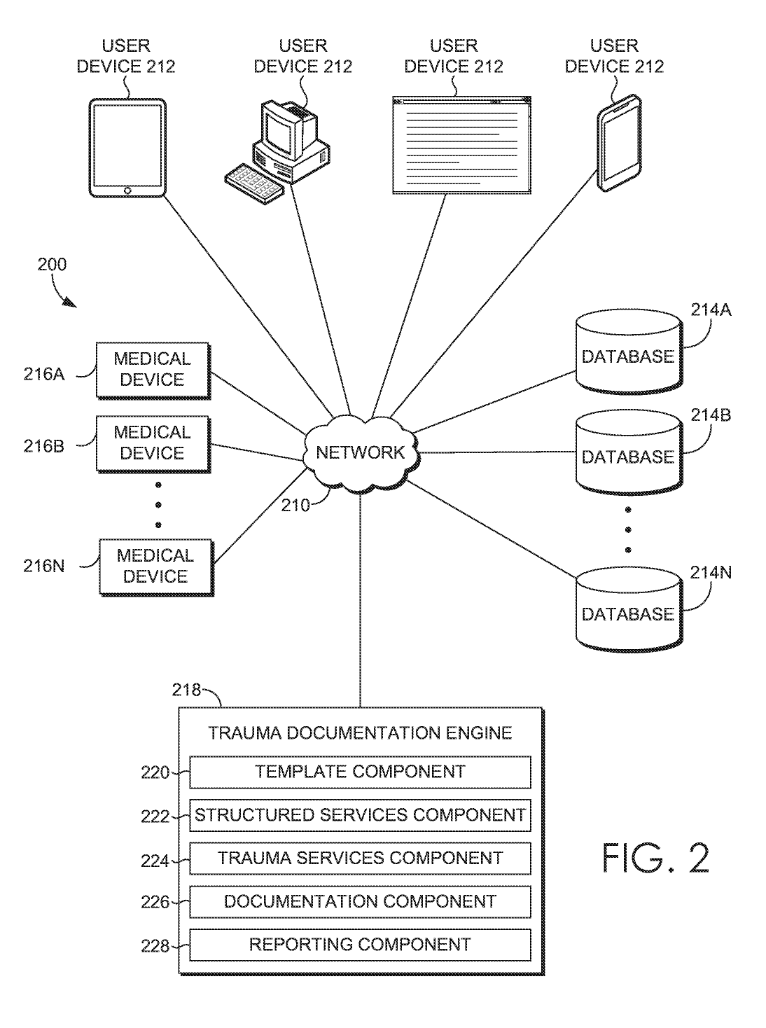

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a user devices 212, one or more medical devices 216A-216N, trauma documentation engine 218, and one or more databases 214A-214N, all in communication with one another via a network 210. The network 210 may include, without limitation, one or more secure local area networks (LANs) or wide area networks (WANs). The network 210 may be a secure network associated with a facility such as a healthcare facility. The secure network 210 may require that a user log in and be authenticated in order to send and/or receive information over the network 210.

In some embodiments, one or more of the illustrated components/modules may be implemented as stand-alone applications. In other embodiments, one or more of the illustrated components/modules may be distributed across multiple trauma documentation engines 218. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the trauma documentation engine 218 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The database(s) 214A-214N is configured to provide information to and store information communicated by, for example, the trauma documentation engine 218. The information stored in association with the database(s) 214A-214N is configured to be searchable for one or more items of information stored in association therewith. The information stored in association with the database(s) 214A-214N may comprise information received from or used by various components of the trauma documentation engine 218 (e.g., templates, surveys, EMRs, and the like).

In embodiments, the database(s) 214A-214N may store EMRs of patients associated with one or more healthcare facilities. EMRs may comprise electronic clinical documents such as surveys, trauma documentation, including images, clinical notes, orders, summaries, reports, analyses, information received from trauma documentation engine 218 and medical devices 216A-216N, or other types of electronic medical documentation relevant to a particular patient's condition and/or treatment. Electronic clinical documents contain various types of information relevant to the condition and/or treatment of a particular patient and can include information relating to, for example, patient identification information, images, alert history, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, clinician assignments, and a host of other relevant clinical information. The content and volume of such information in the database(s) 214A-214N is not intended to limit the scope of embodiments of the present invention in any way.

User device(s) 212 may be any type of computing device used within a healthcare facility to receive, display, and send information to a user, such as a clinician. User device(s) 212 may be capable of communicating via the network 210 with the trauma documentation engine 218, databases 214A-214N, or medical devices 216A-216N. Such devices may include any type of mobile and portable devices including cellular telephones, personal digital assistants, tablet PCs, smart phones, and the like.

User device(s) 212 are configured to display information to a clinician via a display. The information may include communications initiated by and/or received by the trauma documentation engine 218. Embodiments are not intended to be limited to visual display but rather may also include audio presentation, visual presentation, combined audio/visual presentation, and the like.

Components of the trauma documentation engine 218 may include a processing unit, internal system memory, and a suitable system bus for coupling various system components, including one or more data stores for storing information (e.g., files and metadata associated therewith). The trauma documentation engine 218 typically includes, or has access to, a variety of computer-readable media.

The computing system environment 200 is merely exemplary. While the trauma documentation engine 218 is illustrated as a single unit, it will be appreciated that the trauma documentation engine 218 is scalable. For example, the trauma documentation engine 218 may in actuality include a plurality of computing devices in communication with one another. The single unit depictions are meant for clarity, not to limit the scope of embodiments in any form.

As shown in FIG. 2, the trauma documentation engine 218 comprises, in various embodiments a template component 220, a structured services component 222, a trauma services component 224, and a documentation component 226. In some embodiments, one or more of the components may be implemented as stand-alone applications. It will be understood that the components illustrated in FIG. 2 are exemplary in nature and in number and should not be construed as limiting. Any number of components may be employed to achieve the desired functionality within the scope of embodiments hereof.

After a trauma call has been initiated, preliminary information may be received from emergency medical services. Based on the received preliminary information, template component 220 is generally configured to provide at least one trauma template via a trauma display on a user device 212. The trauma templates may be received from database 214A-214N and are utilized to build trauma documentation comprising modal windows.

A clinician may open up to two modal windows of the trauma display. In some embodiments, a clinician may only open one of each type of modal window at a time. Modal windows may correspond to a component container or a survey container. Survey containers may seek a variety of information from a clinician that is relevant to a point in time of the trauma patient's care. Component containers may provide discrete information for the patient such as vitals, Glasgow coma scale, procedures, and the like. The discrete information may be received from the clinician via the clinician device or from one or more medical devices.

Structured services component 222 is generally configured to select information provided by or to the trauma display in an appropriate format to build the trauma documentation. Structured services component 222 provides the selected information to documentation component 226. Structured services component 222 may also select the type of documentation that is being generated. For example, structured services component 222, in various embodiments, may select information to generate a clinical note, documentation in the EMR, or a National Trauma Data Bank (NTDB) report.

Trauma services component 224 is generally configured to determine, based on information provided by or to the trauma display, what should or should not be displayed. For example, the modal windows may be interactive and contain embedded logic. The embedded logic may cause trauma services component 224 to hide or reveal information based on information that is received from a clinician or a medical device. Further, trauma services component 224 may utilize the information to provide clinical decision support. In this way, trauma services component 224 may provide workflows, recommended orders, initiate communication with other clinicians, and the like. For example, an injury to the chest may be documented (or provided in patient codes), trauma services component 224 may take into account the proper CPR that needs to be performed on a patient (rather than general CPR, where traditional chest compressions might be detrimental to a patient with a chest injury).

Documentation component 226 is generally configured to generate documentation relevant to the trauma event on a single screen. For example, vital signs, CPR information, treatment information, orders, and the like can all be documented during a given trauma event on a single screen. In embodiments, documentation component 226 receives information selected by structured services component 222 and/or provided by trauma services component 224 to generate documentation in the EMR. In embodiments, documentation component 226 receives user selection of a recommended order via the trauma services component 224 and initiates the recommended order. Documentation component 226 may additionally prompt, via the trauma display, for additional information given a time lapse. In this way, a timing engine may determine that a predetermined amount of time has lapses since something has been done (documentation, treatment, etc.) and, accordingly, the documentation component 226 prompts for the necessary item to be completed.

Reporting component 228 is generally configured to generate reports relevant to the trauma event. In embodiments, reporting component 228 receives information selected by structured services component 222 and/or provided by trauma services component 224 to generate a clinical note. In embodiments, reporting component 228 receives information selected by structured services component 222 and/or provided by trauma services component 224 to generate an NTDB report.

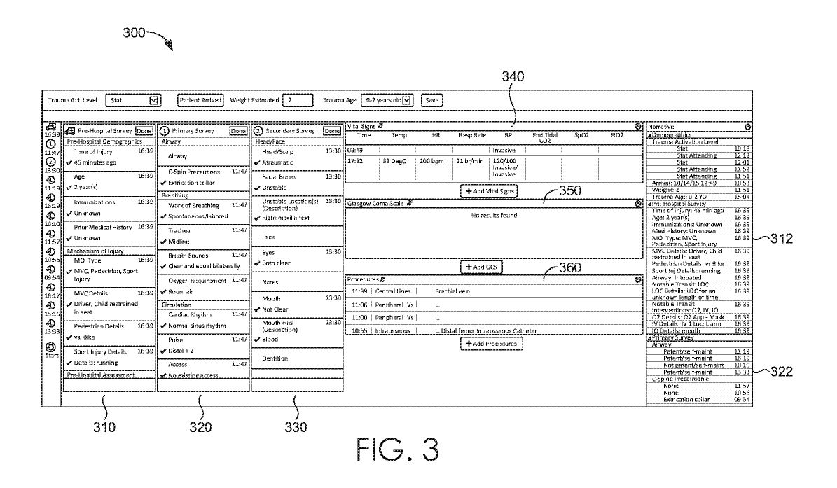

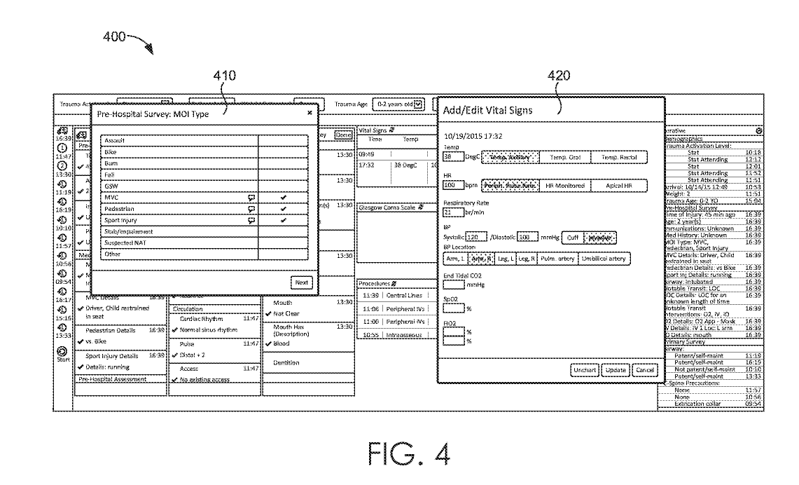

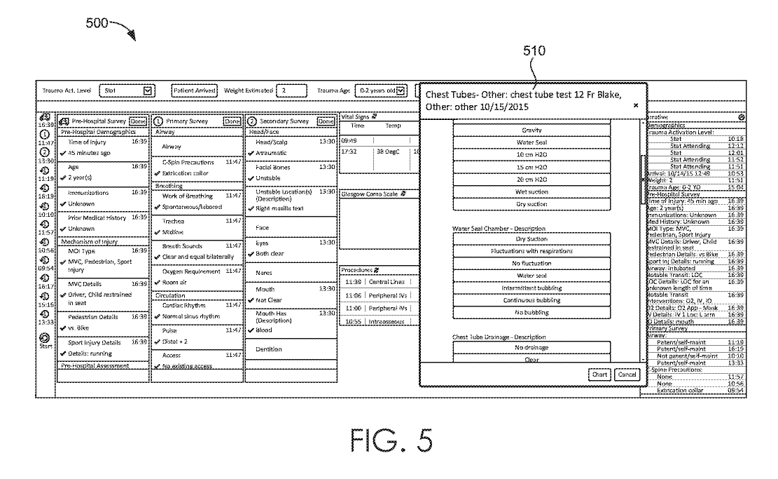

With reference to FIGS. 3-5, illustrative screen displays 300, 400, 500 of embodiments of the present invention are shown. It is understood that each of the illustrative screen displays are connected logically, such that they comprise a user interface designed for integrating pre-hospital encounters into an EMR. The screen displays may appear in any order and with any number of screen displays, without regard to whether the screen display is described or depicted herein. The screen displays provide tools that enable trauma documentation to be integrated into EMR.

Trauma display 300 displays a dashboard comprising information relevant to a trauma event. Trauma display 300 may be viewed on and interacted with by a clinician via any clinician device. Trauma display comprise various modal windows 310, 320, 330, 340, 350, 360. In this example, modal windows 310, 320, 330 are survey containers. In contrast, other modal windows 340, 350, 360 are component containers. A summary 312, 314 of the survey containers may be provided enabling the clinician to readily identify how a patient's condition may have changed over time. Additionally, the trauma display 300 enables a clinician to review the changes by playing through the trauma event by selecting a specific point in time the dashboard was edited.

Trauma display 400 displays a dashboard with two modal windows 410, 420 open. As illustrated, a survey container (modal window 410) and a component container (modal window 420) are open. The survey container enables a clinician to walk through a survey that helps document that trauma event. Based on selections made (or narratives added), other containers, templates, or workflows may be revealed by the trauma display. Information provided and received by the trauma display 400 may be utilized to generate real-time structured documentation in an EMR. Additionally, certain actions may be performed based on these selections (or narratives). For example, an NTDB report may be generated, an order may be generated (or recommended), or a clinical note may be populated. In this way, the trauma display 400 provides real-time decision support.

Trauma display 500 displays a dashboard with one modal window 510 open. As illustrated, a component container (modal window 510) is open. The component container in this example enables a clinician to order and document a chest tube for a trauma patient. The component container may be prepopulated with information relevant to the order or may enable a clinician to make selections for the order that is then integrated into the EMR.

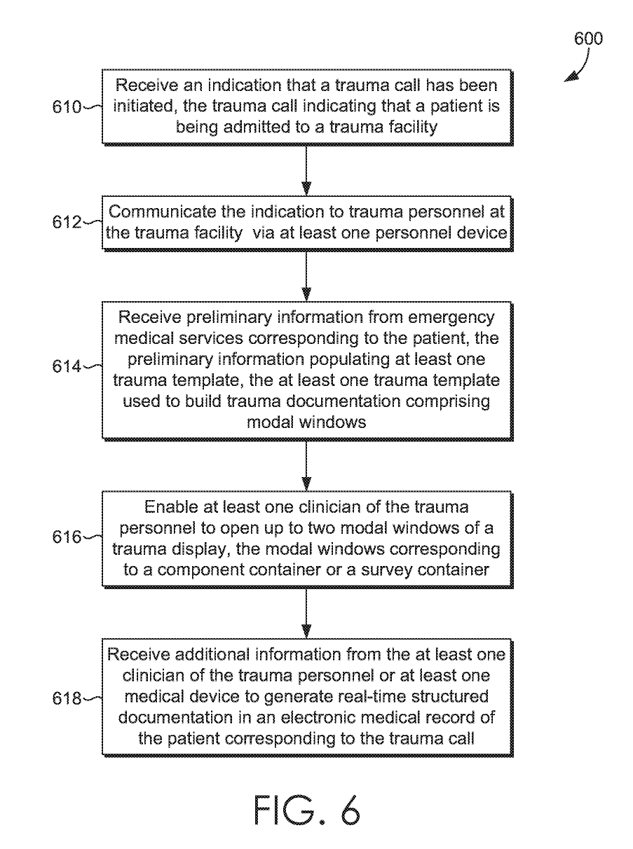

Turning now to FIG. 6, a flow diagram is provided illustrating a method 600 for integrating trauma documentation into an EMR, in accordance with an embodiment of the present invention. Initially, as shown at step 610, an indication that a trauma call has been initiated is received. The trauma call indicates that a patient is being admitted to a trauma facility. The indication is communicated to trauma personnel at the trauma facility via at least one personnel device, at step 612. At step 614, preliminary information is received from emergency medical services corresponding to the patient. The preliminary information populates at least one trauma template that is used to build trauma documentation comprising modal windows. At least one clinician of the trauma personnel is enabled to open up to two modal windows of a trauma display, at step 616. The modal windows correspond to a component container or a survey container. In embodiments, each of the component container and the survey container allows only one modal window open at a time. The component container may include a vitals component, a Glasgow coma score component, a procedures component, and an orders component. At step 618, additional information is received from the at least one clinician of the trauma personnel or at least one medical device. The additional information is utilized to generate real-time structured documentation in an EMR of the patient corresponding to the trauma call. In some embodiments, resources for patients at the trauma facility are prioritized based on at least a portion of the additional information from the at least one clinician of the trauma personnel or the at least one medical device.

In some embodiments, the preliminary information that populated the at least one trauma template is utilized to generate a clinical note template. In some embodiments, the real-time structured documentation is utilized to populate the clinical note template. In some embodiments, the real-time structured documentation is utilized to generate an NTDB report. In some embodiments, the real-time structured documentation is utilized to generate an order for the patient.

In some embodiments, the trauma template includes embedded logic. The embedded logic may hide at least one question on the trauma template based on at least a portion of the additional information from the clinician of the trauma personnel or the medical device. At least one modal window may be revealed based on at least a portion of the additional information from the clinician of the trauma personnel or the medical device.

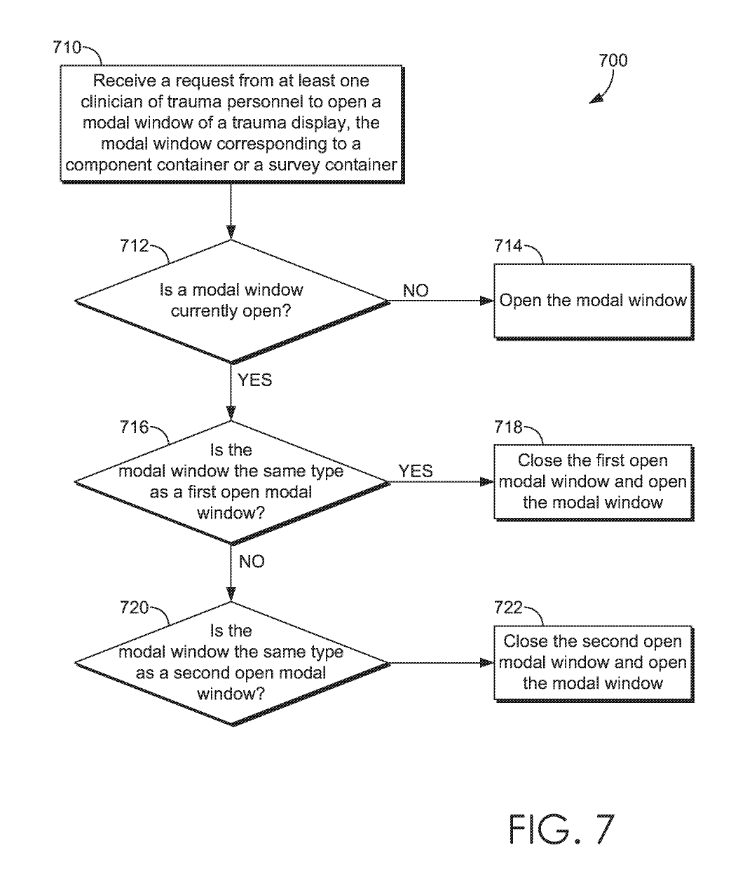

Referring now to FIG. 7, a flow diagram is provided illustrating a method 700 for integrating trauma documentation into an EMR, in accordance with an embodiment of the present invention. Initially, as shown at step 710, a request from at least one clinician of trauma personnel is received to open a modal window of a trauma display. The modal window corresponds to a component container or a survey container. At step 712, it is determined whether a modal window is currently open. If no modal window is currently open, the modal window is opened at step 714. If a modal window is currently open, it is determined, at step 716, whether the modal window is the same type (e.g., component container or survey container) as a first open modal window.

Still referring to FIG. 7, if the modal window is the same type as the first open modal window, the first open modal window is closed, at step 718, and the modal window is opened. If the modal window is not the same type as the first open modal window, it is determined, at step 720, whether the modal window is the same type as a second open modal window. If the modal is the same type as the second open modal window, the second open modal window is closed, at step 722, and the modal window is opened.

In some embodiments, an indication that a trauma call has been initiated is received. The trauma call indicates that a patient is being admitted to a trauma facility. The indication may be communicated to the trauma personnel at the trauma facility via at least one personnel device. Preliminary information may be received from emergency medical services corresponding to the patient. The preliminary information may automatically populate at least one trauma template that is used to build trauma documentation comprising modal windows.

In some embodiments, at least one clinician of the trauma personnel is enabled to open up to two modal windows of the trauma display via at least one personnel device. The modal windows correspond to a component container or a survey container. Additional information may be received from the at least one clinician of the trauma personnel via the at least one personnel device or at least one medical device to generate real-time structured documentation in an electronic medical record of the patient corresponding to the trauma call. The real-time documentation may be utilized, in various formats, to populate a clinical note, generate a NTDB report, and/or generate or recommend an order for the patient.

As can be understood, the present invention provides systems, methods, and user interfaces for integrating trauma documentation into an EMR. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media having computer-executable instructions embodied thereon, that when executed, perform a method for integrating trauma documentation into an electronic medical record (EMR), the method comprising:
receiving an indication that a trauma call has been initiated, the trauma call indicating that a patient is being admitted to a trauma facility;
communicating the indication to trauma personnel at the trauma facility via at least one personnel device;
receiving preliminary information from emergency medical services corresponding to the patient, the preliminary information populating at least one trauma template, the at least one trauma template used to build trauma documentation comprising modal windows;
enabling at least one clinician of the trauma personnel to open up to two modal windows of a trauma display, the modal windows corresponding to a component container or a survey container; and
receiving additional information from the at least one clinician of the trauma personnel or at least one medical device to generate real-time structured documentation in an electronic medical record of the patient corresponding to the trauma call.

2. The media of claim 1, wherein the component container and the survey container allows only one modal window open at a time.

3. The media of claim 1, wherein the component container includes a vitals component, a Glasgow coma score component, a procedures component, and an orders component.

4. The media of claim 1, further comprising utilizing the preliminary information that populated the at least one trauma template to generate a clinical note template.

5. The media of claim 4, further comprising utilizing the real-time structured documentation to populate the clinical note.

6. The media of claim 1, further comprising utilizing the real-time structured documentation to generate a National Trauma Data Bank (NTDB) report.

7. The media of claim 1, further comprising utilizing the real-time structured documentation to generate an order for the patient.

8. The media of claim 1, wherein the at least one trauma template includes embedded logic.

9. The media of claim 8, wherein the embedded logic hides at least one question on the at least one trauma template based on at least a portion of the additional information from the at least one clinician of the trauma personnel or the at least one medical device.

10. The media of claim 9, further comprising revealing at least one modal window based on at least a portion of the additional information from the at least one clinician of the trauma personnel or the at least one medical device.

11. The media of claim 1, further comprising prioritizing resources for patients at the trauma facility based on at least a portion of the additional information from the at least one clinician of the trauma personnel or the at least one medical device.

12. One or more computer storage media having computer-executable instructions embodied thereon, that when executed, perform a method for integrating trauma documentation into an electronic medical record (EMR), the method comprising:
receiving a request from at least one clinician of trauma personnel to open a modal window of a trauma display, the modal window corresponding to a component container or a survey container;
upon determining more than one open modal window is already open,
determining:
a) the modal window is a same type as a first open modal window, closing the first open modal window, and opening the modal window;
b) the modal window is a same type as a second open modal window, closing the second open modal window, and opening the modal window; and
upon determining less than two modal windows are currently open, opening the modal window.

13. The media of claim 12, further comprising receiving an indication that a trauma call has been initiated, the trauma call indicating that a patient is being admitted to a trauma facility.

14. The media of claim 13, further comprising communicating the indication to the trauma personnel at the trauma facility via at least one personnel device.

15. The media of claim 14, further comprising receiving preliminary information from emergency medical services corresponding to the patient, the preliminary information populating at least one trauma template, the at least one trauma template used to build trauma documentation comprising modal windows.

16. The media of claim 15, further comprising enabling at least one clinician of the trauma personnel to open up to two modal windows of the trauma display, the modal windows corresponding to a component container or a survey container.

17. The media of claim 16, further comprising receiving additional information from the at least one clinician of the trauma personnel or at least one medical device to generate real-time structured documentation in an electronic medical record of the patient corresponding to the trauma call.

18. The media of claim 17, further comprising utilizing the real-time documentation to populate the clinical note, generate a National Trauma Data Bank (NTDB) report or generate an order for the patient.

19. A computerized system comprising:
one or more processors; and
a non-transitory computer storage media storing computer-useable instructions that, when used by the one or more processors, cause the one or more processors to:
receive a request from at least one clinician of trauma personnel to open a modal window of a trauma display, the modal window corresponding to a component container or a survey container;
upon determining more than one open modal window is already open:
a) determine the modal window is a same type as a first open modal window, close the first open modal window, and open the modal window;
b) determine the modal window is a same type as a second open modal window, close the second open modal window, and open the modal window; and
upon determining less than two modal windows are currently open, open the modal window.

20. The system of claim 17, wherein the non-transitory computer storage media further stores computer-useable instructions that, when used by the one or more processors, cause the one or more processors to:
receive an indication that a trauma call has been initiated, the trauma call indicating that a patient is being admitted to a trauma facility;
communicate the indication to the trauma personnel at the trauma facility via at least one personnel device;
receive preliminary information from emergency medical services corresponding to the patient, the preliminary information populating at least one trauma template, the at least one trauma template used to build trauma documentation comprising modal windows;
enable at least one clinician of the trauma personnel to open up to two modal windows of the trauma display, the modal windows corresponding to a component container or a survey container; and
receive additional information from the at least one clinician of the trauma personnel or at least one medical device to generate real-time structured documentation in an electronic medical record of the patient corresponding to the trauma call.
